(19) United States
(12) Patent Application Publication
(10) Pub. No.: US 2007/0241853 A1
(43) Pub. Date: Oct. 18, 2007

(54) Transformer

(75) Inventors: Ching-Sheng Yang, Taipei City (TW); Su-Hua Wu, Taipei Hsien (TW); Shu-Chen Wang, Taipei Hsien (TW)

Correspondence Address: BIRCH STEWART KOLASCH & BIRCH, PO BOX 747, FALLS CHURCH, VA, 22040-0747, US

(73) Assignee: Taipei Multipower Electronics Co., Ltd.

(21) Appl. No.: 11/401,947

(22) Filed: Apr. 12, 2006

(51) Int. Cl. H01F 27/30

(52) U.S. Cl. 336/208

(57) ABSTRACT

A transformer includes an electrically insulative bobbin, a primary winding and a secondary winding installed in the bobbin, and a ferrite core set for acting with the windings, a secondary side of the bobbin having a plurality of winding grooves for receiving the secondary winding and a plurality of partition flanges respectively disposed at two sides of each winding groove, each partition flange having a locating groove extending around the periphery for receiving a part of the secondary winding and two notches respectively transversely extending from the locating groove at two opposite sides in reversed directions for guiding the secondary winding out of the locating groove to the two winding grooves at two opposite sides of the respective partition flange.

### BACKGROUND OF THE INVENTION

1. Field of the Invention

The present invention relates to a transformer and more particularly, to an improved structure of transformer, which facilitates installation of the secondary winding and prevents a potential difference between two winding grooves in the secondary side.

2. Description of the Related Art

Following fast development of high technology, various flat-panel displays such as TFT LCDs, PDPs, FPDs, etc. have been disclosed and have appeared on the market to substitute for CRTs. Currently, a LCD usually uses CCFLs (Cold Cathode Fluorescent Lamps) for the backlight, and an inverter circuit for driving the backlight. However, in order to satisfy high voltage output, a high voltage transformer may be used to substitute for an inverter. However, following the development of big size LCDs, the number and size of CCFLs for the backlight are relatively increased, in consequence the driving voltage for the transformer is also increased.

A conventional high voltage transformer for this purpose, as shown in FIGS. 5 and 6, comprises a bobbin A and a ferrite core set B. The bobbin A has a primary winding A1 and a secondary winding A2. The secondary side of the bobbin A has a plurality of partition flanges A21, defining a plurality of winding grooves for the winding of the enameled wire to form the desired secondary winding A2. In consideration of the cost, a high voltage transformer of the aforesaid conventional design is used to drive two CCFLs C and D that are connected in parallel. However, because there is an impedance difference between the two CCFLs C and D, unequal shunt currents I₁ and I₂ are respectively transmitted to the two CCFLs C and D, resulting in a different brightness between the CCFLs C and D. Further, when the number of CCFLs is increased, a relatively thicker enameled wire should be used for making the desired secondary winding A2. However, the use of a relatively thicker enameled wire for the secondary winding A2 requires a relatively wider winding space, and makes the high voltage transformer relatively bigger, and the cost of the high voltage transformer will be relatively higher.

During application, the aforesaid conventional high voltage transformer has drawbacks as follows:

1. During winding of the enameled wire for the secondary winding A2, the enameled wire must be extended over each partition flange A21, and a potential difference may occur at the area around each partition flange A21 that may result in an arc effect to burn out the transformer during charging/discharging action.

2. The potential difference at the enameled wire around each partition flange A21 weakens the pressure resistance of the transformer, thereby shortening the service life.

Therefore, it is desirable to provide a transformer that eliminates the aforesaid drawbacks.

### SUMMARY OF THE INVENTION

The present invention has been accomplished under the circumstances in view. In one embodiment of the present invention, the transformer comprises an electrically insulative bobbin, which has a center through hole longitudinally extending through two distal ends thereof and a primary side and a secondary side surrounding the center through hole, a primary winding and a secondary winding respectively installed in the primary side and the secondary side of the electrically insulative bobbin, and a ferrite core set, which has a first ferrite core member mounted in the center through hole of the electrically insulative bobbin, and a second ferrite core member disposed outside the electrically insulative bobbin in contact with the ends of the first ferrite core member. The secondary side of the electrically insulative bobbin comprises a plurality of winding grooves for receiving the secondary winding, and a plurality of partition flanges respectively disposed at two sides of each of the winding grooves. Each partition flange has a locating groove extending around the periphery thereof for receiving a part of the secondary winding and two notches respectively transversely extending from the locating groove at two opposite sides in reversed directions for guiding the secondary winding out of the locating groove to the two winding grooves at two opposite sides of the respective partition flange. The arrangement of the secondary side of the bobbin for the secondary winding eliminates the occurrence of a potential difference, thereby preventing an over voltage.

### BRIEF DESCRIPTION OF THE DRAWINGS

FIG. 1 is an oblique top elevation of two bobbins for transformer according to the present invention.

FIG. 2 is an oblique bottom elevation of FIG. 1.

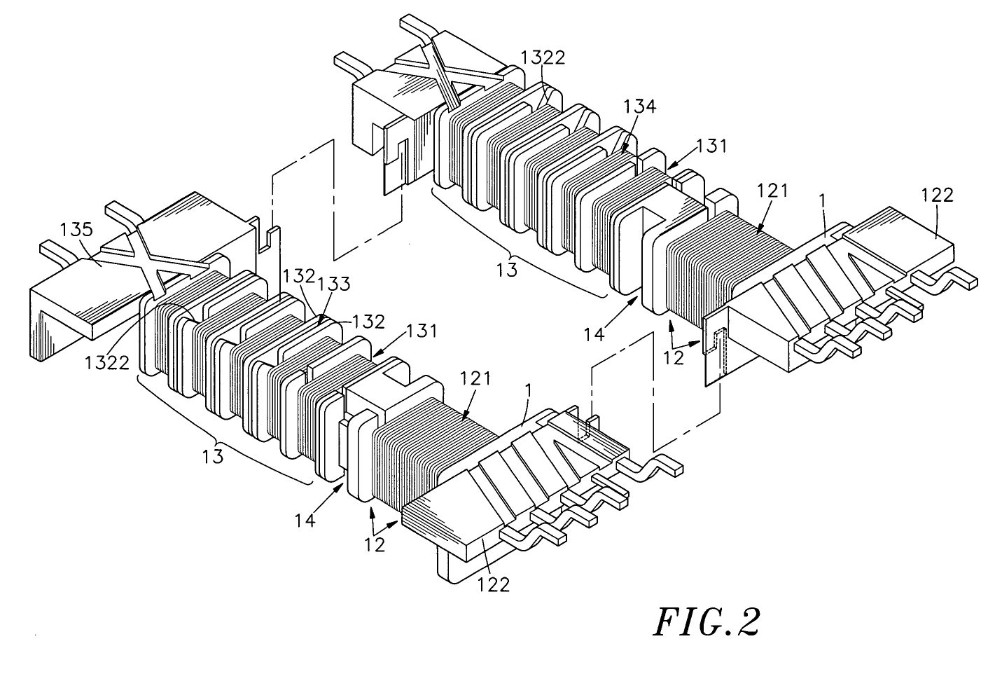

FIG. 3 is an exploded view of a transformer in accordance with a first embodiment of the present invention.

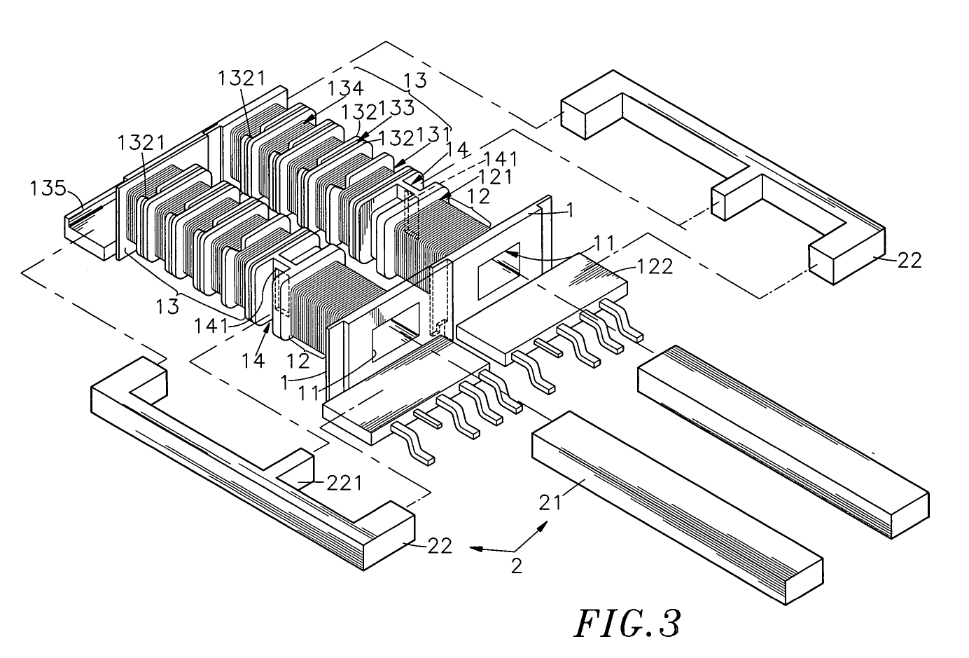

FIG. 4 is an elevational assembly view of the transformer according to the first embodiment of the present invention.

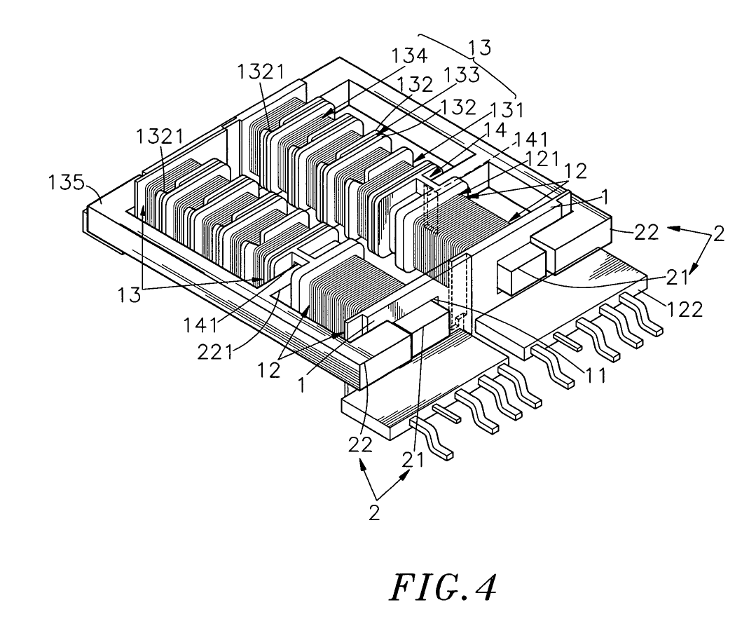

FIG. 5 is an exploded view of a transformer according to the prior art.

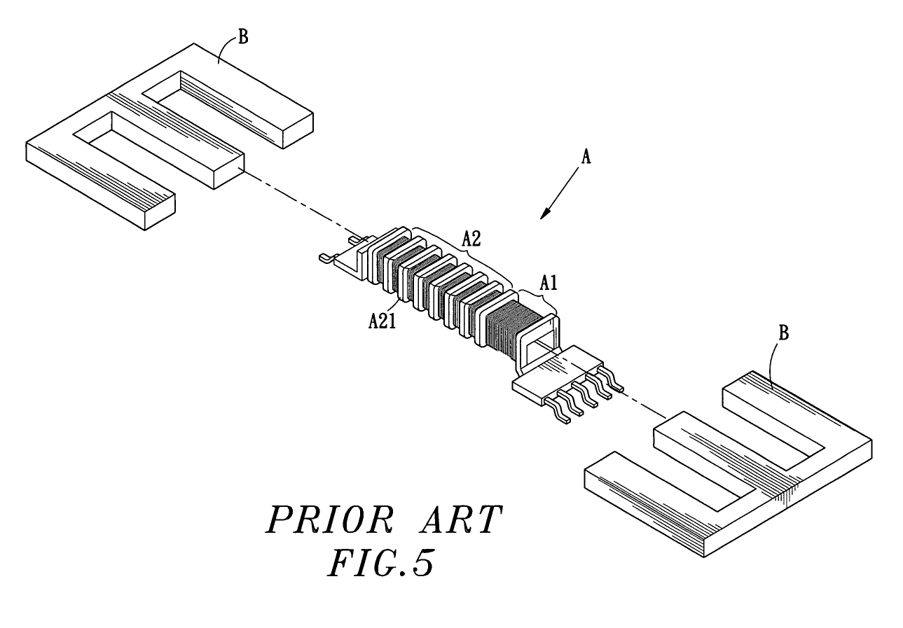

FIG. 6 is a circuit diagram of the transformer according to the prior art.

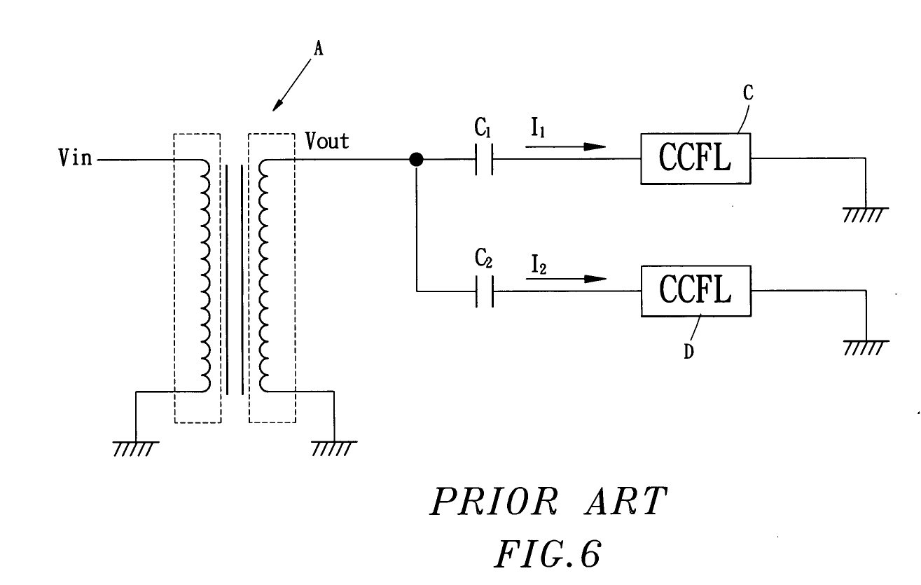

### DETAILED DESCRIPTION OF THE PREFERRED EMBODIMENT

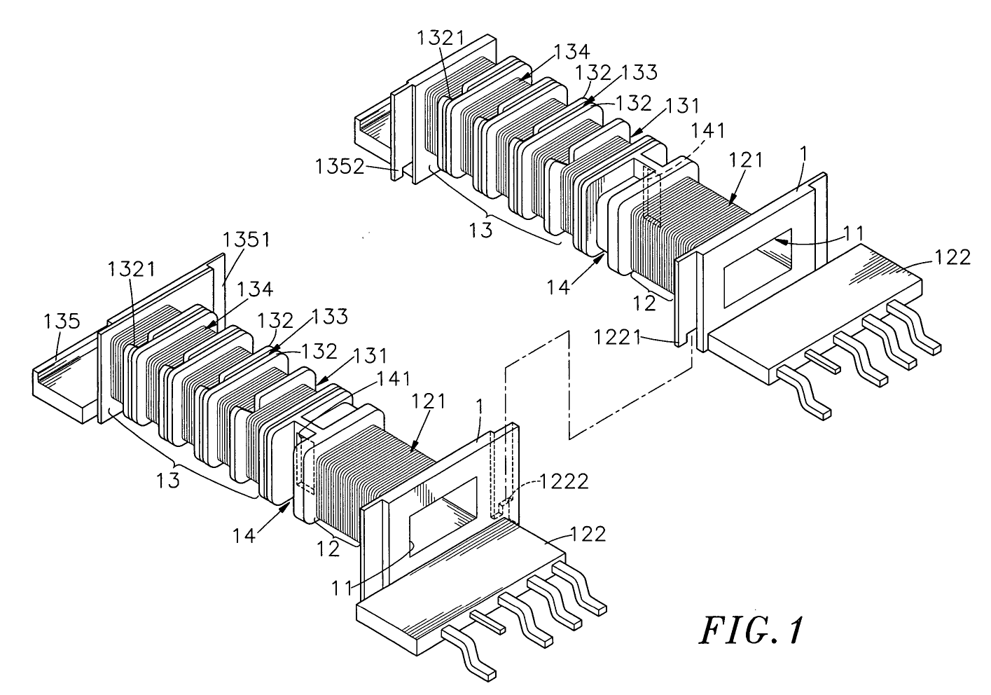

Referring to FIGS. 1˜4, a transformer in accordance with a first embodiment of the present invention is shown comprised of at least one bobbin 1 and at least one ferrite core set 2. According to this embodiment, the transformer is comprised of two bobbins 1 and two ferrite core sets 2.

Each bobbin 1 is made of electrically insulative material, comprising a longitudinal center through hole 11 extending through the two distal ends, a first end block 122 extending from one end thereof below the elevation of the longitudinal center through hole 11, a second end block 135 extending from the other end thereof below the elevation of the longitudinal center through hole 11, a primary side 12 and a secondary side 13 provided around the periphery between the first end block 121 and the second end block 135, and a spacer 14 set between the primary side 12 and the secondary side 13. The secondary side 13 comprises a plurality of winding grooves 131 and a plurality of partition flanges 132 separating the winding grooves 131. Each partition flange 132 has a locating groove 133 extending around the periphery, a top notch 1321 transversely leftwards extending from the locating groove 133 at the top side, and a bottom notch 1322 transversely rightwards extending from the locating groove 133 at the bottom side. The spacer 14 has an opening 141 in communication with the longitudinal center through hole 11.

Each ferrite core set 2 comprises a first ferrite core member 21 and a second ferrite core member 22. The second ferrite core member 22 has a protruding portion 221 perpendicularly protruded from one side.

During installation, an enameled wire is wound round the primary side 12 to form a primary winding 121, and an enameled wire is wound round the secondary side 13 to form a secondary winding 134. The enameled wire for the secondary winding 134 is wound round one of the winding grooves 131 and then extended through the bottom notch 1322 of the adjacent partition flange 132 and then wound round the locating groove 133 of the adjacent partition flange 132 and then extended out of the adjacent partition flange 132 through the top notch 1321 of the adjacent partition flange 132 into the next winding groove 131. After installation of the secondary winding 134, the enameled wire of the secondary winding 134 is prohibited from protruding over the periphery of the partition flanges 132.

The first ferrite core member 21 of each ferrite core set 2 is inserted through the longitudinal center through hole 11 of the associating bobbin 1, and the second ferrite core member 22 of the respective ferrite core set 2 is provided outside the associating bobbin 1 to have the protruding portion 221 be inserted through the opening 141 of the spacer 14 into the longitudinal center through hole 11 of the associating bobbin 1 to contact the respective first ferrite core member 21.

When in use, magnetic paths are produced through the ferrite core sets 2. By means of the protruding portion 221 of the second ferrite core member 22, the primary winding 121 and the secondary winding 134 at each bobbin 1 form a double magnetic path structure in which the induction between the protruding portion 221 of the second ferrite core member 22 and the secondary winding 134 increases the transformer's leakage inductance and coupling effect, achieving the desired resonance.

According to the aforesaid embodiment, the partition flanges 132 of the secondary side 13 of the bobbin 1 each have the locating groove 133 for receiving the enameled wire of the secondary winding 134 and the top notch 1321 and the bottom notch 1322 at the top and bottom sides of the locating groove 133 for separating the lead-in portion and lead-out portion of the enameled wire, thereby extending the creepage distance between each two adjacent winding grooves 131 and preventing a potential difference and also improving the pressure resisting power to prolong the service life of the transformer.

Further, the first end block 122 and the second end block 135 of one of the two bobbins 1 are respectively connected to the first end block 122 and the second end block 135 of the other bobbin 1 by means of a dovetail tongue 1221 or 1351 and a dovetail groove 1222 or 1352.

As indicated above, the transformer of the present invention has the following advantages:

1. The partition flanges 132 of the secondary side 13 of the bobbin 1 each have a locating groove 133 for receiving the enameled wire of the secondary winding 134 and a top notch 1321 and a bottom notch 1322 at the top and bottom sides of the locating groove 133 for separating the lead-in portion and lead-out portion of the enameled wire, preventing a potential difference and the occurrence of an arc effect.

2.The enameled wire of the secondary winding 134 is wound round the locating groove 133 of each partition flange 132 and then extending through the top notch 1321 or bottom notch 1322 of the respective partition flange 132 to the adjacent winding groove 13, preventing the occurrence of a potential difference, improving pressure resistance and prolonging the service life of the transformer.

A prototype of transformer has been constructed with the features of FIGS. 1˜4. The transformer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A transformer comprising:
an electrically insulative bobbin, said electrically insulative bobbin comprising a center through hole longitudinally extending through two distal ends thereof, and a primary side and a secondary side surrounding said center through hole;
a primary winding and a secondary winding respectively installed in said primary side and said secondary side of said electrically insulative bobbin; and
a ferrite core set, said ferrite core set comprising a first ferrite core member mounted in said center through hole of said electrically insulative bobbin, said first ferrite core member having two distal ends respectively extended out of the two distal ends of said electrically insulative bobbin, and a second ferrite core member disposed outside said electrically insulative bobbin in contact with the ends of said first ferrite core member;
wherein said secondary side of said electrically insulative bobbin comprises a plurality of winding grooves for receiving said secondary winding, and a plurality of partition flanges respectively disposed at two sides of each of said winding grooves, said partition flanges each having a locating groove extending around the periphery thereof for receiving a part of said secondary winding and two notches respectively transversely extending from said locating groove at two opposite sides in reversed directions for guiding said secondary winding out of said locating groove to the two winding grooves at two opposite sides of the respective partition flange.

2. The transformer as claimed in claim 1, wherein said electrically insulative bobbin further comprises a first end block extending from one end of said primary side and a second end block extended from one end of said secondary side remote from said primary side.

3. The transformer as claimed in claim 1, wherein said first end block has a dovetail tongue and a dovetail groove symmetrically disposed at two opposite sides.

4. The transformer as claimed in claim 1, wherein said electrically insulative bobbin further comprises an end block extending from one end of said secondary side.
